(19) United States
(12) Patent Application Publication
(10) Pub. No.: US 2026/0361403 A1
(43) Pub. Date: Nov. 12, 2026

(54) SYSTEM AND METHOD FOR CLASSIFYING AND QUALIFYING OPTICAL FIBER FOR HIGH-SPEED OPTICAL NETWORKS

(71) Applicant: AT&T Intellectual Property I, L.P., Atlanta, GA (US)

(72) Inventors: Ricky A. Perry, Cumming, GA (US); Stewart Edward Barker, Lucas, TX (US); Lujing Cai, Morganville, NJ (US)

(73) Assignee: AT&T Intellectual Property I, L.P., Atlanta, GA (US)

(21) Appl. No.: 19/199,568

(22) Filed: May 6, 2025

(51) Int. Cl. H04B 10/079; G06N 20/00; H04B 10/25

(52) U.S. Cl. CPC H04B 10/0795; G06N 20/00; H04B 10/25

(57) ABSTRACT

Aspects of the subject disclosure may include, for example, qualifying optical fibers for future high-speed optical transmission using artificial intelligence (AI) techniques. Fiber performance data is collected from various sources, such as OTDR measurements, spectral attenuation tests, polarization mode dispersion measurements, and chromatic dispersion measurements. These data can be integrated into a centralized database, where it can be aggregated, normalized, and stored. An AI model is trained using this integrated data, employing supervised learning with labeled data to predict future values of key performance indicators. The trained model is then applied to current fiber performance data to generate predictions of future performance. Anomaly detection can be performed to identify deviations indicative of fiber aging or damage. Based on these predictions and/or identified anomalies, recommendations can be generated for maintenance, replacement, or upgrade of fiber segments, ensuring a network's readiness for future high-speed optical transmission demands. Other embodiments are disclosed.

### FIELD OF THE DISCLOSURE

The subject disclosure relates to a system and method for classifying and qualifying optical fiber for high-speed optical networks.

### BACKGROUND

The field of optical communications has experienced significant evolution over the past decades, with high-speed data transmission becoming an essential part of modern networks. Fiber networks, which form the backbone of broadband infrastructures, are crucial in enabling a wide array of services. However, many of these fiber installations were deployed years ago under specifications that are increasingly challenged by today's bandwidth demands and advanced transmission protocols. As technology advances, there is a growing emphasis on ensuring that these networks not only meet current performance benchmarks but are also capable of supporting future innovations and increased data rates.

In deploying and maintaining such networks, there is a considerable goal to achieve streamlined evaluation and maintenance of optical fibers to sustain high-performance communications. Network operators and service providers are increasingly seeking means to monitor the condition of their fiber assets consistently and efficiently. This approach is intended to enable proactive planning and maintenance, contributing to cost savings and improved network reliability. In this context, scalable evaluation methods that can be applied across a large number of fiber segments are highly valued as they support informed decision making for strategic network upgrades.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications system in accordance with various aspects described herein.

FIG. 2A is a block diagram illustrating an example, non-limiting embodiment of an optical fiber evaluation system functioning within the communication system of FIG. 1 in accordance with various aspects described herein.

FIG. 2B is a block diagram illustrating an example, non-limiting embodiment of data collection system functioning within the communication system of FIG. 1 and operable with the optical fiber evaluation system of FIG. 2A, in accordance with various aspects described herein.

FIG. 2C is a block diagram illustrating an example, non-limiting embodiment of an optical data network data collection and integration system functioning within the optical fiber evaluation system of FIG. 2A in accordance with various aspects described herein.

FIG. 2D is a block diagram illustrating another example, non-limiting embodiment of an optical fiber classification simulator functioning within the optical fiber evaluation systems of FIGS. 2A and 2D in accordance with various aspects described herein.

FIG. 2E is a block diagram illustrating an example, non-limiting embodiment of an artificial intelligence module adapted for optical fiber classification and functioning within the optical fiber evaluation systems of FIGS. 2A and 2D in accordance with various aspects described herein.

FIG. 2F is a block diagram illustrating an example, non-limiting embodiment of an optical fiber evaluation system functioning within the communication system of FIG. 1 in accordance with various aspects described herein.

FIG. 2G depicts an illustrative embodiment of an optical fiber evaluation process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for using artificial intelligence and/or machine learning to evaluate and qualify optical fibers for future high-speed operation, offering predictive insights and maintenance recommendations to optimize network performance. Other embodiments are described in the subject disclosure.

One or more aspects of the subject disclosure include a device having a processing system including a processor and a memory that stores executable instructions. The instructions, when executed by the processing system, facilitate performance of operations that include generating labeled training data based on optical fiber performance data, wherein the labeled training data are indicative of optical fiber aging and performance degradation and training an artificial intelligence (AI) processing module according to the labeled training data to obtain a trained predictive model adapted to perform qualification of an optical fiber according to aging and performance degradation. The operations further include collecting current fiber performance data of a deployed optical fiber under evaluation and applying the current fiber performance data to the trained predictive model to obtain an estimated performance of the optical fiber under evaluation based on the current fiber performance data and execute pattern recognition to correlate environmental and mechanical factors with performance deterioration. The performance data may include historical performance data as mya have been obtained via measurements, simulated performance data as may have been obtained via simulation, or a combination of both historical and simulated data, e.g., simulated high-speed passive optical network (PON) data.

One or more aspects of the subject disclosure include a process that includes generating, by a processing system including a processor, labeled training data based on performance data of an optical channel, wherein the labeled training data are indicative of performance of an optical channel according to at least one physical property of the optical channel subject to performance degradation during deployment. The process further includes training, by the processing system, an artificial intelligence (AI) processing module according to the labeled training data to obtain a trained predictive model adapted to perform qualification of the optical channel according to the performance degradation, and measuring, by the processing system, current performance of the optical channel to obtain current channel performance data. The process further includes applying, by the processing system, the current channel performance data to the trained predictive model to obtain an estimated performance of the optical channel under evaluation based on the current channel performance data. The performance data may include historical performance data as mya have been obtained via measurements, simulated performance data as may have been obtained via simulation, or a combination of both historical and simulated data, e.g., simulated high-speed PON data.

One or more aspects of the subject disclosure include a non-transitory, machine-readable medium, that includes executable instructions. The instructions, when executed by a processing system including a processor, facilitate performance of operations that include generating labeled training data based on performance data of an optical waveguide. The labeled training data are indicative of performance of the optical waveguide according to at least one physical property of the optical waveguide subject to performance degradation during deployment. The operations further include training an artificial intelligence (AI) processing module according to the labeled training data to obtain a trained predictive model adapted to perform qualification of the optical waveguide according to the performance degradation. Current performance of the optical waveguide under evaluation is measured to obtain current performance data and the current performance data are applied to the trained predictive model to obtain an estimated performance of the optical waveguide under evaluation based on the current performance data. The performance data may include historical performance data as mya have been obtained via measurements, simulated performance data as may have been obtained via simulation, or a combination of both historical and simulated data, e.g., simulated high-speed PON data.

Many existing approaches to fiber quality assessment are challenged by the complexity of accurately determining the condition of aging fiber assets. Traditional evaluation techniques often involve time-intensive, case-by-case measurements of performance parameters, such as signal attenuation, dispersion, and other optical characteristics. These methods frequently rely on specialized testing equipment and the expertise of trained technicians to analyze results effectively. Such practices can be both laborious and costly when applied to extensive, widespread network infrastructures. As a result, the current solutions, while effective in limited applications, may not fully address the need for comprehensive, scalable evaluations across large networks.

The challenges become even more pronounced in network configurations featuring point-to-multipoint architectures, where signal splitting and variable branch lengths introduce additional complexities. Specifically, the design of these systems can lead to unpredictable performance degradation in certain fiber segments, making it difficult to accurately identify sections that may be at risk. Addressing these issues demands a refined methodology capable of integrating multiple performance metrics and delivering predictive insights into fiber health. Thus, there exists an acute need for a more robust characterization approach that can efficiently support the upgrade and maintenance decision-making processes necessary for future high-speed optical transmission networks.

The devices, systems, processes and/or software disclosed herein provide a comprehensive and integrated approach utilizing a comprehensive data analysis platform adapted for characterizing and qualifying aging optical fibers as may be utilized for future high-speed Passive Optical Network (PON) access networks, e.g., being adapted to combine diverse data sources into a centralized analysis framework. In at least some embodiments, artificial intelligence (AI) and/or machine learning (ML) can be utilized, being adapted for characterizing and/or qualifying optical fibers. Such characterizations and/or qualifications may include anomaly detection and/or predictions of characteristics and/or qualifications at some future time, e.g., based on observed and/or otherwise perceived trends in optical fiber aging.

An optical channel, such as an optical waveguide, e.g., an optical fiber, will generally exhibit one or more channel performance characteristics. These characteristics are essential for designing and optimizing optical fiber networks, ensuring they meet the required standards for high-speed and reliable data transmission. By way of example, at least some performance characteristics may be related to the fiber's construction, e.g., its material, a quality of the material, such as a purity of its core and/or cladding materials, whether the materials are substantially free from incursions, other factors of the fiber's construction, e.g., whether it is single mode or multimode, its core and/or cladding diameters, its numerical aperture, its length, its installation configuration, e.g., whether it incorporates one or more splices, connectors, the types of splices and/or connectors, if any, whether it is a point-to-point optical channel or a point-to-multipoint optical channel, and so on. Other performance characteristics of an optical channel, e.g., an optical fiber, may include, without limitation, its cut-off wavelength, its mode field diameter, its bandwidth, its attenuation, its optical return loss, its chromatic dispersion (CD) and/or its polarization mode dispersion (PMD).

Whether a particular fiber and/or fiber network, e.g., a PON, will support optical communications according to a particular standard for high-speed and/or reliable performance may be determined by measuring, evaluating and/or otherwise estimating one or more optical link performance characteristics. These characteristics may be determined according to one or more standards and have been generally observed to move steadily towards operation at higher speeds, e.g., higher data rates, all while ensuring reliability of information communication and/or otherwise transported via the link. Example link performance characteristics may include, without limitation a bit error rate (BER), a signal to noise ratio (SNR), which may be evaluated according to optical signals and/or corresponding electrical signals. Other link performance characteristics may include, without limitation, latency, jitter, and/or throughput.

It is understood that attainable speeds, e.g., data rates, and/or reliability, as may be measured, calculated, simulated and/or otherwise estimated according to any combination of the example link performance characteristics, may be limited by a physical state of the underlying optical fiber channel. The physical state, in turn, may be represented by any combination of the example channel performance characteristics. Accordingly, it has been recognized that attainable speeds and/or reliability of an optical fiber channel, as may relate to the optical link performance characteristics, will depend upon a physical state of the underlying optical channel as may be represented by any combination of the example optical link performance characteristics.

Without limitation, example data sources can include one or more of Optical Time-Domain Reflectometers (OTDR), optical power sources, detectors and/or wavelength determining devices to perform spectral attenuation tests, equipment adapted to measure and/or otherwise estimate Polarization Mode Dispersion (PMD) and/or Chromatic Dispersion (CD) measurements. Still other example data sources include, without limitation, environmental sensors, e.g., thermometers, hydrometers, solar irradiance sensors, vibration sensors, accelerometers, systems and/or devices configured to measure and/or otherwise estimate network performance metrics, Small Form-factor Pluggable (SFP) devices and/or Optical Network Units (ONU) configured to monitor data.

By leveraging advanced AI/ML techniques for predictive modeling, anomaly detection, pattern recognition, and optimization, the disclosed devices, systems, processes and/or software enable proactive maintenance and early intervention, thereby minimizing downtime and extending fiber lifespan. Alternatively, or in addition, the novel techniques exemplified by the disclosed embodiments address the challenges of passive optical networks (PON), such as high attenuation from splitters and difficulty in identifying specific branches of point-to-multipoint PON configurations that correspond to individual users, through advanced signal processing techniques and/or AI/ML algorithms. Such holistic approaches ensure a thorough understanding of fiber performance and aging, providing a scalable solution for the future of high-speed optical transmission.

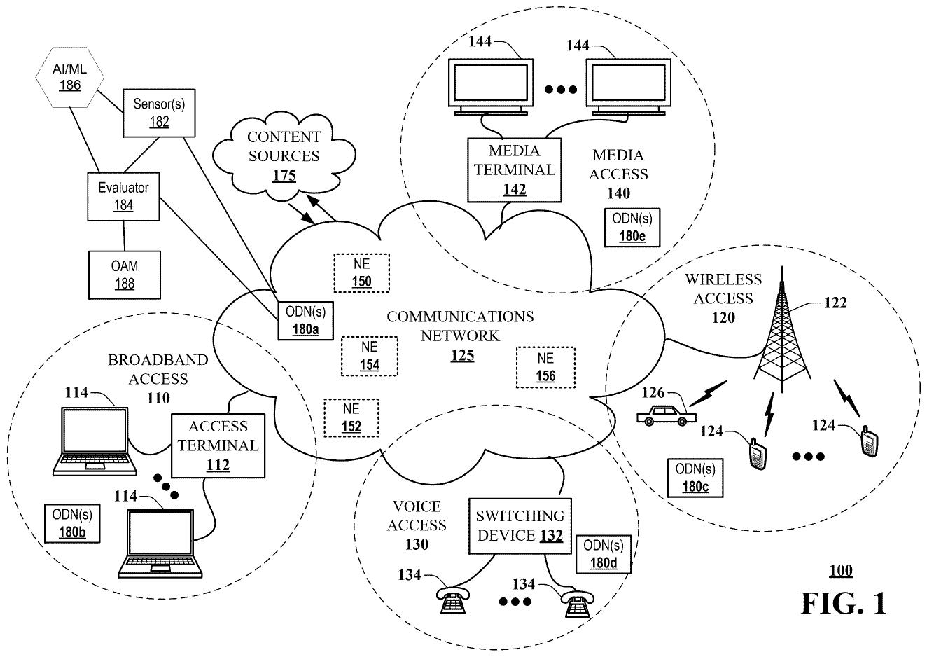

Referring now to FIG. 1, a block diagram is shown illustrating an example, non-limiting embodiment of a communication system 100 in accordance with various aspects described herein. For example, the communication system 100 can facilitate in whole or in part generation of labeled training data based on historical optical fiber performance data and indicative of optical fiber aging and performance degradation and training of an AI processing module according to the labeled training data to obtain a trained predictive model adapted to perform qualification of an optical fiber according to aging and performance degradation. Current fiber performance data of a deployed optical fiber under evaluation can be collected and applied to the trained predictive model to obtain an estimated performance of the optical fiber under evaluation based on the current fiber performance data and execute pattern recognition to correlate environmental and mechanical factors with performance deterioration. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminals. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the communication system 100 includes one or more optical distribution networks (ODN). For example, the communications network 125 may include one or more ODNs 180a. Alternatively, or in addition, one or more of the broadband access network 110 may include one or more ODNs 180b, the wireless access network 120 may include one or more ODNs 180c, the voice access network 130 may include one or more ODNs 180d and/or the media access network 140 may include one or more ODNs 180e. The ODNs 180a through 180e, generally 180, may include one or more passive optical networks (PONs) that may include one or more optical fiber segments, optical fiber splitters and/or opto-electric devices, such as fiberoptic transmitters, receivers and/or transceivers, generally referred to herein as small formfactor pluggable (SFP) devices.

In at least some embodiments, the communication system 100 includes one or more sensors 182 configured to measure, monitor, detect and/or otherwise sense parameters related to the physical state, environment, electrical, optical and/or network operability of the example ODNs 180, any PONs contained therein, and devices contained therein and/or any fiber segments contained therein, all referred to generally herein as PON segments. In at least some embodiments, the communication system 100 further includes a PON segment evaluator 184 configured to evaluate one or more PON segments of the ODNs 180 base at least in part on data obtained by the one or more sensors 182. In at least some embodiments, the communication system 100 further includes an artificial intelligence and/or machine learning (AI/ML) module 186 configured to determine a quality, a characteristic, and/or an operational performance capability as may relate to a classification and/or a rating value of a PON segment. In at least some embodiments, the AI/ML module 186 trains an AI/ML model to provide a label, e.g., a quality, a characteristic, and/or an operational performance capability as may relate to a classification and/or a rating of one or more PON segments based on a set of features corresponding at least in part to measured parameters obtained via the sensors 182.

In at least some embodiments, the communication system 100 includes an operation, administration and/or maintenance (OAM) system 188. It is envisioned that the OAM system 188 may be configured to receive a label, e.g., a quality, a characteristic, and/or an operational performance capability as may relate to a classification and/or a rating of one or more PON segments. In some embodiments, the label may indicate detection of an anomaly associated with an identifiable PON segment. Alternatively, or in addition, the label may indicate that a PON segment is suitable to accommodate one or more new and/or otherwise advanced PON functions, such as advanced modulations and/or greater data rates, bandwidths, and so on.

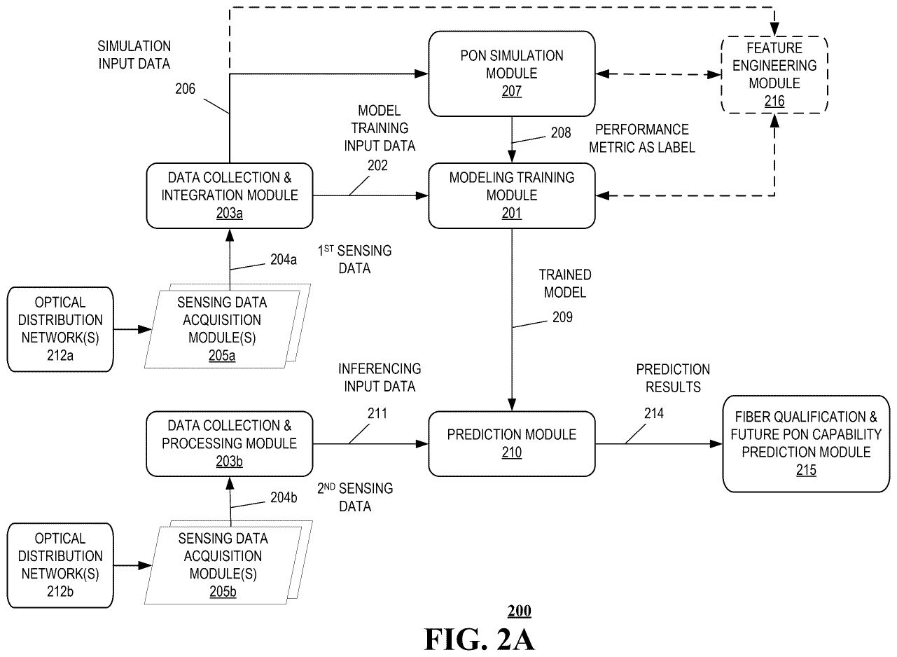

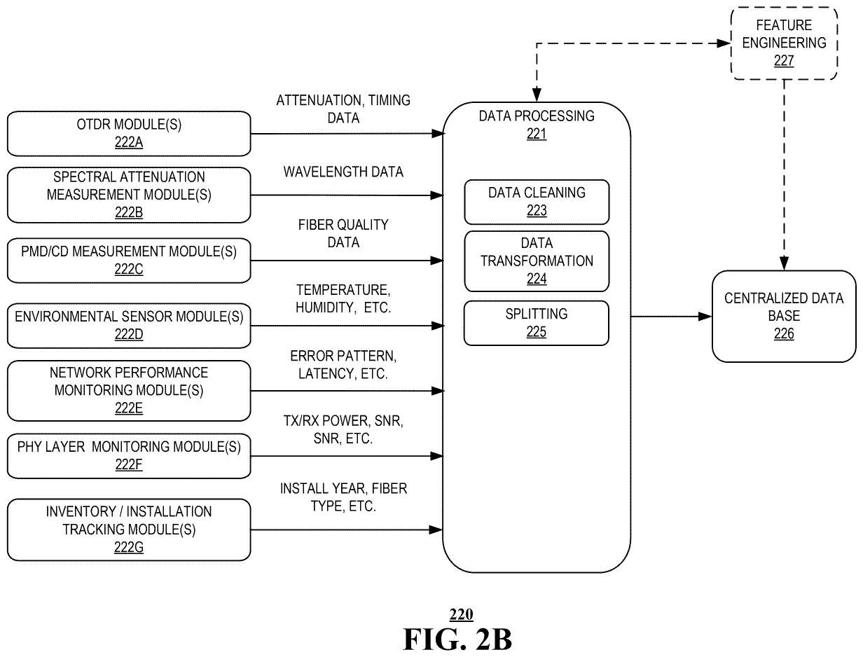

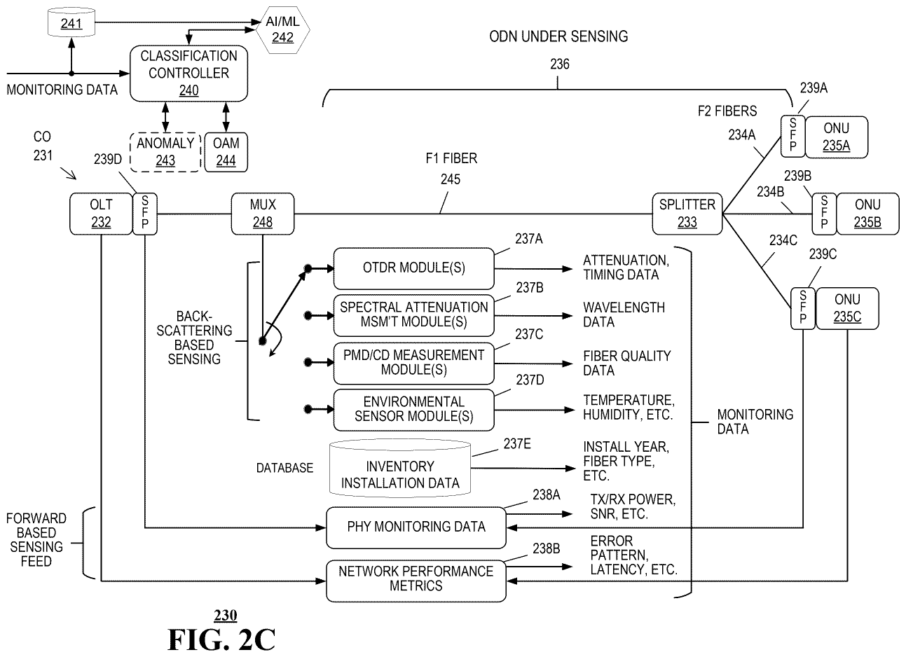

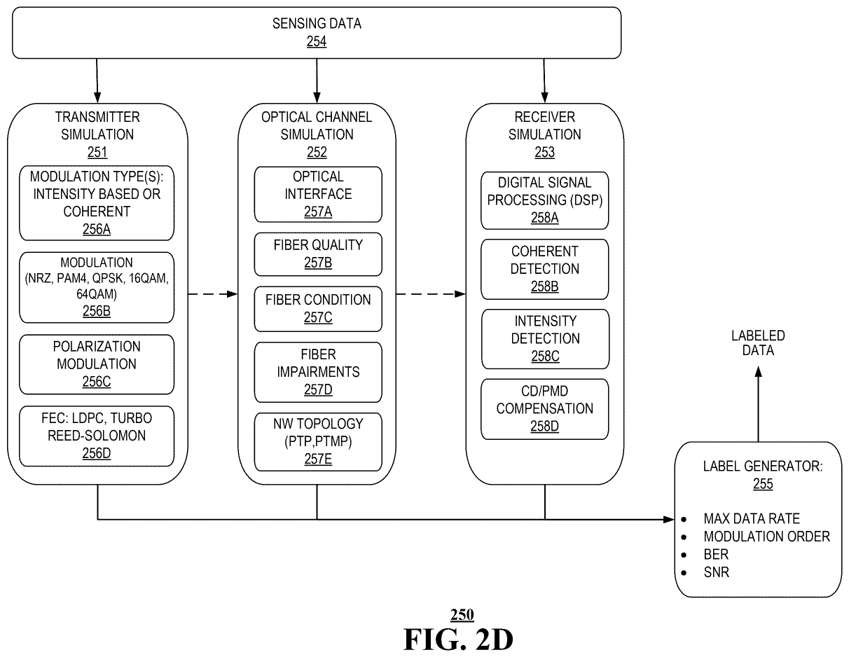

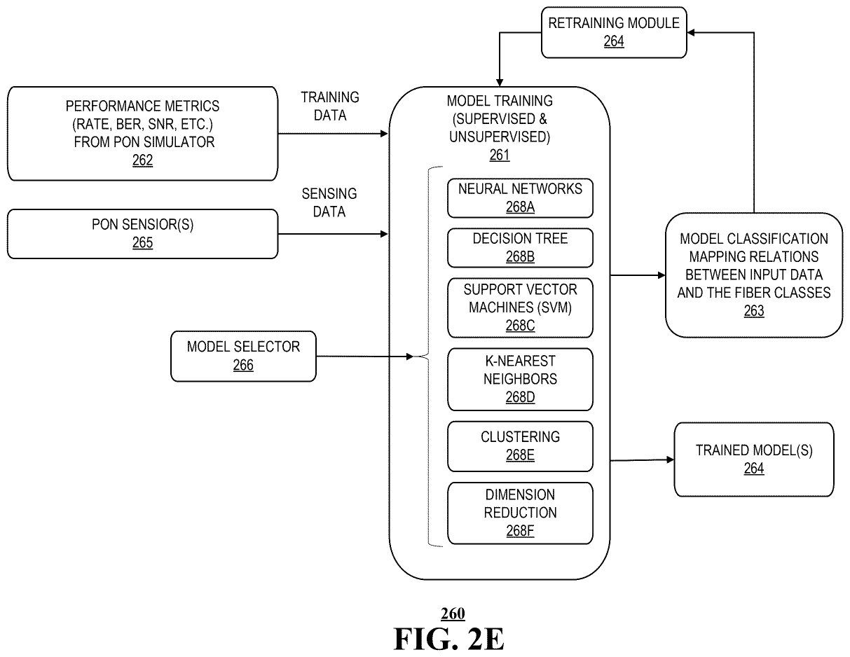

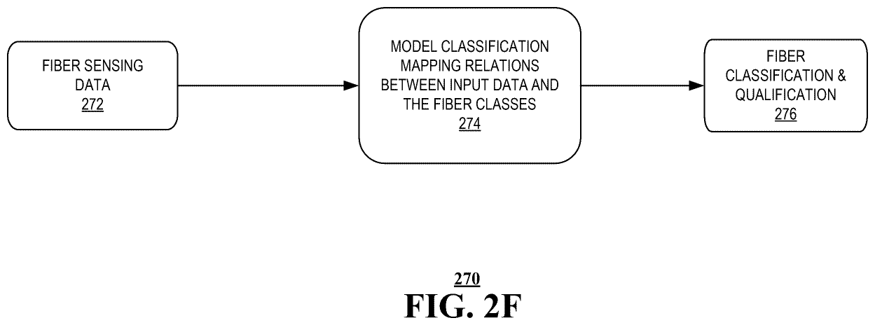

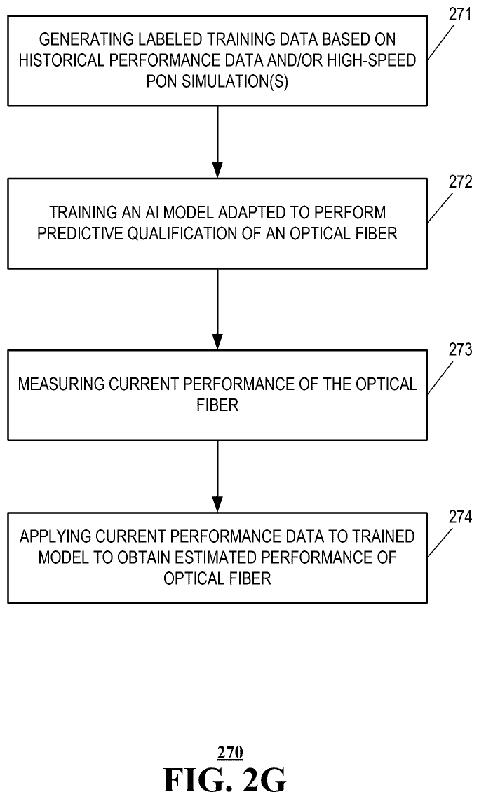

FIG. 2A is a block diagram illustrating an example, non-limiting embodiment of an optical fiber evaluation system 200 functioning within the communication system of FIG. 1 in accordance with various aspects described herein. The example optical fiber evaluation system 200 is generally configured to assess and/or predict a performance capability of a passive optical network (PON) and/or optical fiber segment thereof. More particularly, the example optical fiber evaluation system 200 is configured to assess a performance capability of an existing, deployed PON network in view of future PON requirements. For example, a PON and/or optical fiber segment thereof, may have been designed, deployed, and in at least some scenarios, maintained according to a first performance requirement according to a first type and/or range of optical fiber communications and/or a first type of optical network technology. At some later time, the existing, deployed PON can be re-evaluated to determine one or more operational capabilities in view of current and/or new technologies and/or enhanced requirements. It is envisioned that such new technologies and/or requirements may require more stringent performance capabilities than those required for prior and/or current operations. In at least some embodiments, one or more features of an optical distribution network (ODN) 212a, 212b, generally 212, related to supporting such new technologies and/or enhanced requirements are generally referred to herein as new performance indexes. Namely, the new performance indexes may represent and/or otherwise correspond to a second performance requirement according to a second type and/or range of optical fiber communications and/or a second type of optical network technology.

The example optical fiber evaluation system 200 includes a first group of one or more sensing data acquisition modules 205a. The first group of sensing data acquisition modules 205a can be configured to measure, monitor and/or otherwise sense one or more of a variety of parameters of a system, such as the example ODN 212a. It is understood that the ODN 212a may include a PON, a device and/or segment thereof, e.g., one or more of an optical fiber, an optical splitter, an optical source and/or detector operable to convert between optical and electrical domains. For example, at least some of the first group of sensing data acquisition modules 205a can be configured to measure PON parameters related to operation of a physical layer of an optical network including the PON. Alternatively, or in addition, at least some of the first group of sensing data acquisition modules 205a can be configured to measure networking parameters at one or more other layers of an optical network including the PON, such as a data link layer, a transport layer, a networking layer, a session layer, a presentation layer and/or an application layer. In at least some embodiments, at least some of the first group of sensing data acquisition modules 205a can be configured to measure other parameters, such as operation, administration and maintenance parameters, environmental parameters, and so on.

The example optical fiber evaluation system 200 further includes a first data collection and integration module 203a configured to receive first sensing data 204a from the first group of sensing data acquisition modules 205a. The first data collection and integration module 203a may perform one or more operations on the first sensing data 204a to prepare model training input data 202. For example, the first data collection and integration module 203a may buffer at least some of the first sensing data 204a. Alternatively, or in addition, the first data collection and integration module 203a may perform a translation, a scaling, a combining and/or other transformation as may be useful in preparing the model training input data 202.

The first data collection and integration module 203a, in turn, provides the model training input data 202 to a model training module 201. In the context of artificial intelligence and/or machine learning (AI/ML) the model training input data 202 can be considered as feature data. The model training module 201 can be configured to process the model training input data 202, i.e., the feature data, to produce modeled results. According to the example embodiments, and without limitation, the model training module 201 can be configured to produce modeled results according to one or more performance indexes, including new performance indexes of a PON, device and/or segment thereof, based on a current and/or future PON performance requirement.

The example optical fiber evaluation system 200 further includes a PON simulation module 207 that can be configured to simulate operation of a PON, device and/or segment thereof according to one or more aspects of performance of the PON, device and/or segment thereof. For example, when assessing and/or predicting a performance capability of a passive optical network (PON), device and/or segment thereof, the PON simulation module 207 may be configured to simulate operation of the PON, device and/or segment thereof according to the performance capability, such as an existing and/or new capability according to an existing and/or new performance index, e.g., a future high-speed performance index. In operation, the PON simulation module 207 may receive simulation input data 206, e.g., from the first data collection and integration module 203a. In at least some embodiments, the simulation input data 206 includes at least a portion of the model training input data 202. The PON simulation module 207 may perform one or more simulations based on the simulation input data 202 to produce one or more performance metrics 208 according to the applicable performance indexes. In the context of AI/ML, the one or more performance metrics 208 can be considered as label data.

In at least some embodiments, the model training module 201 operates upon the model training input data 202 to produce prediction results. The prediction results can be compared with the corresponding performance metrics 208 as label data. An error may be calculated and used to adjust one or more adjustable parameters of an AI/ML model. The process may repeat using the same model training input data 202 until the resulting error falls below some tolerable threshold value. At such times, a model produced by the model training module 201 may be considered suitably trained.

In at least some embodiments, the example training process may be conducted according to a “black box” approach, otherwise known as a data-driven approach by which the model is developed without requiring any substantial manual manipulation of the model. In at least some embodiments, the model includes a neural network (NN) including at least an input layer of artificial neurons adapted for processing the model training input data 202, i.e., the feature data, and an output layer of artificial neurons adapted for providing modeled outputs suitable for comparison with the simulation results. In at least some embodiments, the NN includes a deep neural network (DNN) including input layer of artificial neurons, an output layer of artificial neurons and one or more internal or hidden layers of artificial neurons. Thus, the model training input data 202 can produce a trained model 209 including an interconnected arrangements of artificial neurons action functions and corresponding weighting values that when presented with the model training input data 202 produces results that differ less that some tolerable error from the performance metrics 208 as label data.

In at least some embodiments, the example optical fiber evaluation system 200 further includes a feature engineering module 216 configured to transform raw data, e.g., the example simulation input data 206, into one or more meaningful features that can enhance performance of the resulting trained model 209. A feature engineering process can benefit from domain expertise and creativity to identify and construct features that capture the underlying patterns and relationships within the data. Effective feature engineering can significantly improve the accuracy and efficiency of machine learning models by providing them with more informative inputs. Techniques used in feature engineering include, without limitation, scaling, normalization, and encoding categorical variables, as well as creating new features through mathematical transformations, aggregations, or interactions between existing features. Alternatively, or in addition, feature selection techniques can be employed to identify relevant features, e.g., the most relevant features, thereby reducing dimensionality and improving model interpretability. By focusing on the quality and relevance of features, feature engineering helps models learn more effectively, leading to better predictions and insights. This step is particularly important in complex datasets where raw data may not directly reflect the factors influencing the target variable. Overall, feature engineering is a vital process that bridges the gap between raw data and model training, ensuring that machine learning algorithms can leverage the most pertinent information to achieve optimal results.

The model training input data 202 serves as the foundation for the model training module 201, where AI/ML models are trained to predict current and/or future performance metrics and/or fiber capabilities. An outcome of the example training process is the trained model 209, which then can be provided to and/or otherwise applied to a prediction module 210. The prediction module 210, in turn, can be configured to generate insights into a current and/or future performance of the PON, device and/or segment thereof based on the inferencing input data 211.

The example optical fiber evaluation system 200 further includes a second data collection and integration module 203b configured to receive second sensing data 204b from a second group of sensing data acquisition modules 205b operable to measure one or more parameters of the ODN 212b. The second data collection and integration module 203b may perform one or more operations on the second sensing data 204b to prepare inferencing input data 211. For example, the second data collection and integration module 203b may buffer at least some of the second sensing data 204b. Alternatively, or in addition, the second data collection and integration module 203b may perform a translation, a scaling, a combining and/or other transformation as may be useful in preparing the inferencing input data 211. In at least some embodiments, the first and second group of sensing data acquisition modules 205a, 205b may share at least some operable elements. It is conceivable that in at least some embodiments, the first and second group of sensing data acquisition modules 205a, 205b can be serviced from a common set of sensing data acquisition modules.

The second data collection and integration module 203b, in turn, provides the inferencing input data 211 to a prediction module 210. The prediction module 210 can be configured to process the inferencing input data 211 to produce modeled results. According to the example embodiments, and without limitation, the prediction module 210 can be configured to produce prediction results 214 by way of the trained model 209 and according to one or more performance indexes, including new performance indexes of a PON, device and/or segment thereof, based on a current and/or future PON performance requirement. In at least some embodiments, the first and second data collection and integration modules 203a, 203b may share at least some operable elements. It is conceivable that in at least some embodiments, the first and second data collection and integration modules 203a, 203b can be serviced from a common, e.g., the same module.

In at least some embodiments, the example optical fiber evaluation system 200 optionally includes a qualification and/or prediction module 215 (shown in phantom). According to the illustrative example, the qualification/prediction module 215 receives prediction results from the prediction module 210. The qualification/prediction module 215 can be configured to evaluate a suitability of the PON, device and/or segment thereof for future applications and/or requirements, e.g., future high-speed applications. It can be appreciated that in at least some embodiments, the qualification/prediction module 215 can offer strategic recommendations for network planning. Overall, the example optical fiber evaluation system 200 illustrates a comprehensive system that integrates data collection, model training, and predictive analysis to support future network enhancements.

FIG. 2B is a block diagram illustrating an example, non-limiting embodiment of data collection system 220 functioning within the communication system 100 of FIG. 1 and operable with the optical fiber evaluation system 200 of FIG. 2A, in accordance with various aspects described herein. The example data collection system 220 is configured to process and analyze data for the classification and qualification of a PON, device and/or segment thereof of one or more ODNs 212a, 212b, generally 212 (FIG. 2A). The data collection system 220 includes examples of the first and/or second groups of sensing data acquisition modules 205a, 205b, generally 205 (FIG. 2A). For example, the sensing acquisition modules 205 can include one or more optical time domain reflectometer (OTDR) module(s) 222a adapted to perform attenuation and/or timing data, e.g., return loss measurements, one or more spectral attenuation measurement module(s) 222b adapted perform wavelength and/or wavelength related attenuation measurements, one or more polarization mode dispersion and/or a chromatic dispersion (PMD/CD) measurement module(s) 222c adapted to perform ODN, e.g., fiber quality measurements, environmental sensor module(s) 222d adapted to perform measurements of one or more of temperature, humidity, salinity, barometric pressure, vibrational data, acceleration data, and so on, one or more network performance monitoring module(s) 222e adapted for determining network performance related to the ODN, e.g., error rates, error patterns, latency and so on, e.g., by way of an optical line terminal (OLT) as may be employed at a central office, and/or an optical network unit (ONU) as may be employed at a subscriber premises, such as a home and/or business. Alternatively, or in addition, the sensing acquisition modules 205 can include one or more physical layer monitoring module(s) 222f, e.g., capable of measuring one or more of optical transmit power, optical receiver power, an optical signal to noise ratio (SNR), a corresponding electrical SNR, a bit error rate (BER), a forward error correction (FEC) rate, and the like. In at least some embodiments, the physical layer monitoring module(s) 222f include small form factor pluggable (SFP) devices, which may be deployed within a PON, a device and/or a segment thereof of the ODN 212, e.g., at fiber termina and adapted to provide monitoring data. In at least some embodiments, and without limitation, the sensing acquisition modules can include an operation, administration and management (OAM) module adapted to provide inventory and/or installation tracking module 222g, e.g., installation year, fiber and/or cable type, etc. These modules 222a through 222g, can be referred to generally as sensing acquisition modules 222, and configured to feed into a data processing module 221, which can be configured for handling and transforming the collected data.

By way of illustrative example, the OTDR module(s) 222a can provide attenuation and/or timing data to the data processing module 221, the spectral attenuation measurement module(s) 222b can provide wavelength and/or wavelength-related attenuation data to the data processing module 221, the PMD/CD measurement module(s) 222c can provide fiber quality data, e.g., related to one or more of PMD and/or CD to the data processing module 221. Likewise, the environmental sensor module(s) 222d can provide environmental data, such as temperature, humidity, salinity, barometric pressure, vibration data, acceleration data and the like to the data processing module, the network performance monitoring module 222e can provide network performance metrics, such as error data, error patterns, latency, etc., as may be obtained from one or more of an OLT and/or an ONU, to the data processing module 221, and the SFP monitoring modules. In at least some embodiments, the physical layer monitoring module(s) 222f may include small form factor pluggable (SFP) devices deployed within a PON, device and/or segment thereof of the ODN 212, e.g., at fiber termina and adapted to provide monitoring data. In at least some embodiments, and without limitation, the sensing acquisition modules can include an inventor and/or installation tracking module 222g adapted to provide inventory and/or installation data. These modules 222a through 222g, generally 222, can feed into a data processing module 221, which can be configured for handling and transforming the collected data.

The interconnections between these elements begin with the collection of various types of data from the modules, such as attenuation and timing data from the OTDR module(s) 222a, wavelength data from the spectral attenuation measurement module(s) 222b, fiber quality data from the PMD/CD measurement module(s) 222c, and environmental factors like temperature and humidity from the environmental sensor module(s) 222d. Network performance metrics, including error patterns and latency, are gathered from the network performance monitoring module(s) 222e, while transmission and reception power data are collected from the physical layer monitoring module(s) 222f. Installation year and/or fiber type information are examples of data as may be provided by the inventory/installation tracking module 222g.

In at least some embodiments, the data processing module 221 can integrate data obtained from one or more of the diverse example data sources of modules 222a through 222g, generally 222. In at least some embodiments, the data processing module 221 includes one or more modules, such as the example data cleaning module 223, the example data transformation module 224 and the example data splitting module 225. The data cleaning module 223 can be configured performing essential operations such as “cleaning” of data received form the data sources 222, e.g., to remove noise and/or outliers. The data transformation module 224 can be configured to process, e.g., by transformation, data obtained from one or more of the diverse example data sources 222 as may be beneficial to better prepare the data for further processing, e.g., by the simulation module 207, the model training module 201 and/or the prediction module 210 (FIG. 2A), to standardize and/or normalize the data. In at least some embodiments, the data splitting module 225 can be configured to divide a dataset, such as the example data received from the diverse example data sources 222 into different data sets. For example, the different data sets may include one or more of a training dataset, a validation dataset, and/or test datasets.

The processed data generated by the data processing module 221 can be stored in a data repository, such as a database. In at least some embodiments, the database can include a centralized database 226 configured to serve as a foundation for further analysis. In at least some embodiments, the data collection system 220 optionally includes a feature engineering module 227 (shown in phantom). The feature engineering module 227 can be configured to enhance one or more of the example datasets, e.g., by creating new features that may improve model accuracy.

In operation, the data collection system 220 can begin with collecting comprehensive data from various modules 222, each contributing specific metrics and information relevant to ODN performance, e.g., performance of a PON, a device and/or segment thereof. In at least some embodiments, the data processing module 221 can play a crucial role in ensuring the data is clean, consistent, and ready for analysis. Through data cleaning by the data cleaning module 223, the system can remove any irrelevant and/or erroneous data points. By way of example, the data cleaning can include one or more of identify and/or otherwise handling missing values, e.g., by estimation and/or interpolation, by removing duplicates, by detecting and/or otherwise correcting errors and/or by interpolation and/or extrapolating the data as may be beneficial for the purposes of evaluating, characterizing and/or otherwise qualifying an ODN, and/or qualifying a PON, a device and/or a segment provided therein.

In least some embodiments, transforming the data by way of the transformation module 224 can ensure that the data is standardized and/or normalized for effective analysis. By way of example, the data transformation process can include a standardization process, e.g., ensuring that data have a mean and/or a standard deviation. Alternatively, or in addition, the data transformation process can include normalization, e.g., scaling as may be appropriate to ensure a substantially even weighting. Other data transformation processes can include, without limitation binning, which may include converting continuous variables into discrete intervals, e.g., bins. Still other transformation processes may include a scaling, such as a logarithmic transform to scale one or more numerical features to ensure a substantially evening weighting.

A data splitting process as may be performed by the data splitting module 225, can divide the data into subsets for model training and/or validation, thereby ensuring robust and reliable predictive capabilities. The centralized database 226 can serve as a repository for the processed data, thereby facilitating easy access and retrieval for further analysis. The feature engineering module 227 can provide an additional layer of refinement, e.g., creating new features that enhance the predictive power of the models. Overall, FIG. 2B depicts a sophisticated system for data collection, processing, and integration, supporting the accurate classification and qualification of optical fibers for future network enhancements.

FIG. 2C is a block diagram illustrating an example, non-limiting embodiment of an ODN data collection and integration system 230 functioning within the optical fiber evaluation system 200 of FIG. 2A in accordance with various aspects described herein. The example ODN data collection and integration system 230 is configured to assess a performance and health of optical fibers within a network, utilizing a variety of modules and components to collect, process, and analyze data. The key elements of this example system include a central office (CO) 231, a first feeder fiber, referred to as an F1 feeder fiber 245 extending between an OLT 232 at the CO 231 and an optical fiber splitter 233, second feeder fibers, referred to as F2 feeder fibers 234a, 234b, 234c, generally 234, as may extend between the optical fiber splitter 233 and the example optical network units (ONUs) 235a, 235b, 235c, generally 235. In at least some embodiments, the ODN data collection and integration system 230 further includes an optical distribution network (ODN) 236, and various other modules such as one or more OTDR module(s) 237a, one or more spectral attenuation measurement module(s) 237b, one or morePMD/CD measurement module(s) 237c, one or more environmental sensor module(s) 237d, and an inventory installation data module 237e.

The interconnections between these elements extends from the CO 231, which may serve as a hub for the example network, e/g/, connecting to the F1 feeder fiber 245 that carries signals to the optical fiber splitter 233, which divides the signals among multiple F2 feeder fibers 234a, 234b, 234c, each leading between the optical fiber splitter 233 and a respective optical network unit (ONU) 235a, 235b, 235c. These ONUs 235 can be responsible for interfacing with end-user devices and in at least some embodiments, for collecting performance data. In at least some embodiments, the ODN 236 may encompass the entire network configuration, configured according to the illustrative example, to facilitate data acquisition and monitoring in support of PON segment evaluation, characterization and/or qualification.

The example ODN data collection and integration system 230 incorporates various modules to collect and analyze data. For example, the OTDR module(s) 237a are configured to gather attenuation and/or timing data, e.g., return loss data, while the spectral attenuation measurement module(s) 237b are configured to collect wavelength data and/or wavelength attenuation data. The PMD/CD measurement module(s) 237c are configured collect data for assessing fiber quality, e.g., by way of PMD and/or CD measurements, and the environmental sensor module(s) 237d are configured to monitor environmental factors such as temperature, pressure, e.g., atmospheric pressure, vibration, acceleration and humidity. The inventory installation data module 237e is configured to provide information related to equipment and/or optical fiber configuration, operation, administration and/or maintenance, such as installation year, equipment or fiber type, past service activity, and so on. Additional components can include, without limitation, a multiplexer 248 configured to select, coordinate, control and/or otherwise combine collection of monitoring data, from one or more modules, such as the example modules 237a through 237d, and/or data from one or more other sources, such as inventory and/or installation data 237e, as may be obtained from the inventory installation data module 222g (FIG. 2B), physical layer performance data 238a, as may be obtained from the physical layer monitoring module(s) 222f (FIG. 2B), and/or network performance metrics 238b, as may be obtained from the network performance monitoring module(s) 222e (FIG. 2B).

The ODN data collection and integration system 230 also features other measurement devices, such as the example small form-factor pluggable (SFP) devices 239a, 239b, 239c configured to monitor transmission and reception optical and/or electrical power, optical and/or electrical signal-to-noise ratio (SNR), errors and/or error patterns. The ODN data collection and integration system 230 further includes a classification controller 240 configured to manage a classification process that, in at least some embodiments, utilizes an AI/ML system 242. The AI/ML system 242 can be configured to analyze monitored data, e.g., as may be stored in a monitored data repository, e.g., a monitored data database 241, and to provide insights into performance of an ODN, a PON, a device and/or a segment contained therein. The operation, administration and maintenance (OAM) systems 244 can be configured to support ongoing network management, administration and/or optimization.

In operation, ODN data collection and integration system 230 can begin with the CO 231 distributing optical communication and/or optical networking signals through the feeder fibers 245, 234 and splitters 233 to the ONUs 235, where data may be collected and processed by various modules, e.g., the example SFP devices 239a, 239b, 239 c, 239 d, generally 239. The ODN data collection and integration system 230 is configured to integrate at least some of the collected data into a comprehensive analysis framework, leveraging AI/ML techniques to evaluate fiber health and predict future performance. The classification controller 240 and AI/ML system 242 can be configured to work together to provide actionable insights, guiding maintenance and upgrade decisions. Overall, FIG. 2C depicts a robust network configuration for evaluating optical fibers, ensuring optimal performance and reliability in complex network environments.

In at least some embodiments, the ODN data collection and integration system 230 includes an anomaly detector 243. The anomaly detector 243 may be configured to detect and/or otherwise predict anomalies occurring within an ODN and/or a PON segment. For example, the anomaly detector 243 may be in communication with the classification controller 240. As the classification controller operates, e.g., according to a trained AI/ML model to predict a PON segment classification based on a certain combination of features as may be determined at least in part form monitored, it may encounter an anomalous condition. In at least some embodiments, an output of the classification controller 240 can be provided to the anomaly detector 243, which may be configured to detect an anomaly. Anomalies may include, without limitation, a cable break, a component failure, e.g., an SFP failure, a sudden degradation in performance as may be related to a change in an environmental condition, e.g., a fire and/or an earthquake, and so on.

It is envisioned that in at least some embodiments, data collection can be conducted and/or otherwise coordinated from an upstream end of a distributed optical network, i.e., from an input side of a fiber distribution device or splitter as may be performed at the CO 231. Collecting data in this manner can present challenges that include, but are not necessarily limited to, substantial signal loss resulting from optical power division at a splitter device and/or identifying, distinguishing and/or otherwise correlating operational and/or test results obtained at an input end of a fiber optic signal splitter to the optical fiber segments at an output end of the splitter. In at least some embodiments, a multi-path smart OTDR may be used in conjunction with any of the various monitoring, sensing and/or testing disclosed herein. A multi-path smart OTDR system and related methods are described in U.S. Pat. No. 11,606,139, entitled “Multi-Path Smart Optical Time-Domain Reflectometer,” issued on Mar. 14, 2023, the entire contents of which are incorporated herein by reference in its entirety.

FIG. 2D is a block diagram illustrating another example, non-limiting embodiment of an optical fiber classification simulator 250 functioning within the optical fiber evaluation systems 200, 230 of FIGS. 2A and 2D in accordance with various aspects described herein. In at least some embodiments the optical fiber classification simulator 250 provides a more detailed description of an embodiment of the PON simulator module 207 (FIG. 2A). The example optical fiber classification simulator 250 is configured to simulate performance of at least a portion of an ODN, such as a PON, a device and/or a PON segment, e.g., an optical fiber, provided therein under various conditions. The example optical fiber classification simulator 250 comprises one or more of a transmitter simulation module 251, an optical channel simulation module 252, and/or a receiver simulation module 253. These modules 251, 252, 253 receive sensing data 254 and operate independently and/or collectively simulate the one or more aspects of an ODN transmission process, from signal generation to propagation, and ultimately to reception based at least in part on the received sensing data 254.

It is understood that in at least some embodiments, the sensing data 254 can include sensing data 204a, 204b obtained from any of the first and/or second groups of sensing data acquisition modules 205a, 205b (FIG. 2A). Alternatively, or in addition, the sensing data 254 can include simulation input data 206, e.g., obtained from the first data collection and integration module 203a and/or inferencing input data 211 obtained from the second data collection and integration module 203b (FIG. 2A). Alternatively, or in addition, the sensing data 254 can include any combination of the one or more various data items provided by the example sensing acquisition modules 222, processed data provided by the data processing module 221 and/or stored data, e.g., stored data provided by the data processing module 221 as may be stored in a data storage repository, such as the example centralized database 226 (FIG. 2B).

In at least some embodiments, the transmitter simulation module 251 may include one or more of a modulation type simulation module 256a configured to model and/or otherwise simulate transmitter operation according to one or more types of modulation, such as intensity modulation and/or coherent modulation operation, a modulation type simulation module 256b configured to model and/or otherwise simulate transmitter operation according to one or more different types of modulation or modulation formats, such as NRZ, PAM4, QPSK, 16 QAM, and 64 QAM, and/or a polarization module 256c configured to simulation transmitter operation according to one or more polarization modulation techniques. Alternatively, or in addition, the transmitter simulation module 251 may include an error detection and/or correction simulation module 256d configured to model and/or otherwise simulate transmitter operation according to one or more error detection and/or correction techniques, such as forward error correction (FEC) schemes like LDPC and Turbo Reed-Solomon to enhance signal integrity. It is understood that each transmitter simulation module 256a through 256d, generally 256, may be configured to model and/or otherwise simulate operation and/or performance of transmitter, e.g., an optical transmitter, as may be utilized in the ODN, the PON, the device and/or any segment thereof.

In at least some embodiments, the optical channel simulation module 252 simulates and/or otherwise models one or more of an optical interface, a fiber quality, a fiber condition, and/or other impairments such as chromatic dispersion (CD) and polarization mode dispersion (PMD). For example, the optical channel simulation module 252 may include an optical interface simulation module 257a configured to model and/or otherwise simulate optical interface portions of an optical channel. In at least some embodiments, optical interface simulation module 257a may model and/or otherwise simulate operation of one or more electrical-optical interfaces, operation of an optical source, e.g., a laser, including semiconductor lasers, and/or a light emitting diode. Alternatively, or in addition, the optical interface simulation module 257a may be configured to model and/or otherwise simulate an optical coupling to and/or from a source as may depend upon physical properties of the interface, e.g., index matching properties, numerical aperture of the fiber, and so on. Alternatively, or in addition, the optical channel simulation module 252 may include one or more of a fiber quality module 257b configured to model and/or otherwise simulate a quality of an optical channel, e.g., an optical waveguide or fiber, a fiber condition module 257c configured to simulate a condition of an optical fiber, such as number of bends, whether the fiber is an aerial fiber or a buried fiber, an age of the fiber, and so on, and/or a fiber impairment module 257d configured to model and/or otherwise simulate one or more impairments as may be experienced by an optical channel, e.g., an optical waveguide or fiber. Impairments may include, without limitation, bends, kinks, hydrogen infiltration, connector and/or splice discontinuities and so on.

In at least some embodiments, the optical channel simulation module 252 may include network topology simulation module 257e configured to model and/or otherwise simulate one or more aspects of an optical network, such as a topology and/or optical network protocols. Optical topologies may include point-to-point (PTP) configurations in which an optical fiber extends between a source node, e.g., the OLT 232 and a destination node, e.g., the ONU 235 (FIG. 2C). Other optical topologies may include point-to-multipoint (PTMP) configurations in which an optical fiber extends between a source node, e.g., the OLT 232 and multiple destination node, e.g., multiple ONUs 235 as may be enabled by incorporation of one or more signal splitting and/or combining devices, e.g., the example splitter 233 (FIG. 2C). It is understood that in either a PTP and/or a PTMP configuration, the optical signals may be simulated in a so-called downstream direction, e.g., from the OLT 232 to the ONU 235 and/or in a so-called upstream direction, e.g., from one or more of the ONUs 235 to the OLT 232. It is understood that each optical channel simulation module 257a through 257e, generally 257, may be configured to model and/or otherwise simulate operation and/or performance of an optical channel, e.g., an optical fiber, as may be utilized in the ODN, the PON, the device and/or any segment thereof.

In at least some embodiments, the receiver simulation module 253 focuses on the reception and processing of the optical signal. For example, the receiver simulation module 253 may include a digital signal processing (DSP) module 258a configured to model and/or otherwise simulate DSP as may be employed within a receiver utilized within the ODN, the PON, the device and/or any segment thereof. Alternatively, or in addition, the receiver simulator 253 may include one or more of a coherent detection module 258b, e.g., configured to model and/or otherwise simulate a coherent detection process, an intensity detection module 258c, e.g., configured to model and/or otherwise simulate intensity detection, and/or a CD/PMD compensation module 258d, e.g., configured to model and/or otherwise simulate for one or more of CD and/or PMD, each receiver simulation module 258 a through 258 d, generally 258, may be employed to model and/or otherwise simulate performance of a receiver as may be utilized within any portion of the ODN, the PON, the device contained therein and/or any segment thereof.

In at least some embodiments, the optical fiber classification simulator 250 includes a label generator module 255. The label generator module 255 receives sensing data 254 and/or simulation data from one or more of the transmitter simulation module 251, the optical channel simulation module 252 and/or the receiver simulation module 253. The label generator module 255 is configured to produce labeled data based on corresponding feature data as may be determined according to the received data. By way of a nonlimiting example, the labels produced by the label generator module 255 may include one or more of a maximum data rate, a modulation order, bit error rate (BER), and signal-to-noise ratio (SNR), which may serve as performance metrics for evaluating the simulation results. These labels can be used in training, e.g., by the example model training module 201 (FIG. 2A) and/or the AI/ML system 242 (FIG. 2B) for validating the accuracy and effectiveness of a simulation model as may be performed in generation of a trained model 209.

In operation, the optical fiber classification simulator 250 may begin with modeling and/or otherwise simulating operation of a transmitter as may be used in any portion of the ODN, the PON, the device and/or any segment thereof, and in which various modulation formats and/or error detection and/or correction schemes may be applied to a signal. The optical fiber classification simulator 250 may then model and/or otherwise simulate operation of an optical channel, e.g., an optical waveguide or fiber, as may be used in any portion of the ODN, the PON, the device and/or any segment thereof, e.g., accounting for effects of a transmission path, a fiber quality and/or impairments as may be encountered, modeled and/or otherwise simulated in the transmission path. Finally, the optical fiber classification simulator 250 may model and/or otherwise simulate operation of a receiver as may be used in any portion of the ODN, the PON, the device and/or any segment thereof. The receiver simulation module 253 may process the incoming signal, e.g., modeling and/or otherwise simulating DSP techniques as may be used to recover transmitted data. The labeled data generated by the optical fiber classification simulator 250 can provide benchmarks for assessing performance of any portion of the ODN, the PON, the device and/or any segment thereof under simulated conditions. Overall, the example optical fiber classification simulator 250 illustrates an embodiment of a comprehensive simulation system that enables detailed analysis and evaluation of optical fiber performance, supporting the development and optimization of high-speed optical networks.

FIG. 2E is a block diagram illustrating an example, non-limiting embodiment of an artificial intelligence and/or machine learning (AI/ML) system 260 adapted for optical fiber classification and functioning within the optical fiber evaluation systems 200, 250 of FIGS. 2A and 2D in accordance with various aspects described herein. In at least some embodiments, the AI/ML system 260 is configured to train and/or otherwise refine AI/ML models that evaluate, classify and/or otherwise qualify any portion of an ODN, a PON, a device contained therein and/or any segment thereof, e.g., an optical fiber, based on performance metrics, parameters and/or characteristics thereof. According to the illustrative embodiment, the AI/ML system 260 includes one or more of an AI/ML model training module 261 and a model classification module 263 and a retraining module 264. In at least some embodiments, the AI/ML model training module 261 receives training data, e.g., from a PON simulation module 207 (FIG. 2A) and/or from the optical fiber classification simulator 250 (FIG. 2D). By way of nonlimiting example, the training data may include performance metrics received from a PON simulator module 262. Example performance metrics may include, without limitation, one or more of data rate, bit error rate (BER), SNR packet loss, FEC errors, and/or simulated receiver sensitivity. In at least some embodiments, the training data may correspond to planned and/or future requirements as may be related to higher-speed PON operation, greater bandwidth PON operation, different bandwidth PON operation, different PON protocols, and so on.

In at least some embodiments, the AI/ML model training module 261 may receive labeled data, e.g., an association of feature data with corresponding labels as may be provided by one or more of the PON simulator 207, the optical fiber classification simulator 250 and/or the PON simulator 262. Alternatively, or in addition, the AI/ML model training module 261 may receive sensing data from one or more fiber sensors 265. It is understood that the sensing data obtained from the PON sensor(s) 265 that may be used at least in part as feature data for input(s) to the AI/ML model training module 261. The sensing data may include labeled sensing data and/or unlabeled sensing data. For example, in at least some embodiments, the sensing data 254 can include sensing data 204a, 204b obtained from any of the first and/or second groups of sensing data acquisition modules 205a, 205b (FIG. 2A). Alternatively, or in addition, the sensing data can include simulation input data 206, e.g., obtained from the first data collection and integration module 203a and/or inferencing input data 211 obtained from the second data collection and integration module 203b (FIG. 2A). Alternatively, or in addition, the sensing data can include any combination of the one or more various data items provided by the example sensing acquisition modules 222 (FIG. 2B), processed data provided by the data processing module 221 and/or stored data, e.g., stored data provided by the data processing module 221 as may be stored in a data storage repository, such as the example centralized database 226.

According to the illustrative embodiment the AI/ML model training module 261 may be configured to perform supervised training, e.g., utilizing training data received from the PON simulation module 262 and/or sensor data received from the PON sensor(s) 265. These data may include labeled data, e.g., having a suitable label associated with one or more features. Alternatively, or in addition, the model training module 261 may be configured to provide unsupervised training, e.g., utilizing sensing data obtained from the fiber sensor(s) 265. In at least some embodiments, the AI/ML model training module 261 is configured to adjust a model to perform a mapping of relations between input data, i.e., features, and output data, e.g., one or more fiber classes, e.g., as may be determined by the model classification module 263.

In at least some embodiments, the retraining module 264 can be configured to support a retraining process, e.g., in which model classification data mapped to features may be used to further train and/or otherwise retrain and/or refine a training of an AI/ML model as performed by the AI/ML model training module 261. In at least some embodiments, the retraining module may operate automatically. Alternatively, or in addition, it may operate with operator assistance. For example, an automated process and/or an operator may review classifications provided by the AI/ML model training module 261 in view of corresponding sets of features to assess whether the classifications are sensible and/or otherwise accurate. In at least some embodiments, a retraining effort as may be supported by the retraining module 264 may cooperate with subsequent performance assessments, evaluations and/or measurements to obtain a measure of an accuracy of the predicted classification.

In at least some embodiments, the AI/ML model training module 261 may include one or more AI and/or ML models and/or algorithms. For example, the AI/ML model training module 261 may include one or more neural networks 268a configured to characterize any portion of an ODN, a PON contained therein, a device contained therein and/or any segment thereof, referred to generally as a PON segment, based on performance metrics for a high-speed PON simulation provided by the PON simulation module 262. Other model and/or algorithm modules provided by the PON simulation module 262, as may be used in evaluating a PON segment in view of an advanced, e.g., high-speed, PON application, include, without limitation, a decision tree module 268b, a support vector machines (SVM) module 268c, a k-nearest neighbors module 268d, a clustering module 268e and/or a dimension reduction module 268f. Each of the various example AI/ML modules 268a through 268f, generally 268, may be performed alone or in combination with other AI/ML modules 268. In at least some embodiments, the example AI/ML system 260 includes an AI/ML model selector 266 that provides a suitable input to the AI/ML model training module 261 to identify one or more of the AI/ML modules 268 as may be utilized in obtaining a retrained model, e.g., via the retraining module 264.

In operation, the AI/ML system 260 begins with the collection and integration of fiber sensing data and performance metrics, which serve as the foundation for model training. The system employs a variety of algorithms to analyze the data, identifying patterns and correlations that inform the classification process. The retraining module 264 ensures that the models remain up-to-date and responsive to new information, while the model selector 266 fine-tunes the approach to achieve the best results. The model classification mapping can provide a framework for applying the trained models to real-world scenarios, enabling accurate classification and qualification of optical fibers. Overall, the AI/ML system 260 represents a sophisticated system that leverages advanced artificial intelligence and/or machine learning techniques to enhance an evaluation and/or characterization of one or more PON segments.

FIG. 2F is a block diagram illustrating an example, non-limiting embodiment of an optical fiber evaluation system 270 functioning within the communication system 100 of FIG. 1 in accordance with various aspects described herein. The example optical fiber evaluation system 270 is designed to evaluate, classify and/or otherwise qualify optical fibers based on their current condition, which may include a PON segment that has been fielded for a long time, e.g., years, and to predicted performance of an advanced PON technology based on the current condition. Alternatively, or in addition, the example optical fiber evaluation system 270 is designed to predict a future classification and/or qualification of a PON segment based on one or more of a present, a past and a predicted future condition of the PON segment. For example, the optical fiber evaluation system 270 may observe trends in one or more performance parameters of a PON segment and to predict a future performance parameter according to the trends. In at least some embodiments, the predicted future performance may be based at least in part on other data, such as environmental data, observed trends in other PON segments, e.g., in other ODNs and/or other simulation results.

The example optical fiber evaluation system 270 includes several key components, including one or more PON segment sensing modules 272, an AI/ML model classification module 274 and a PON segment evaluation, classification and/or qualification module 276. The AI/ML model classification module 274 may be configured to produce and/or otherwise predict mapping relations between input data, e.g., feature data obtained from the PON sensing module(s) 272 and fiber classes.

The interconnections between these elements begin with the f PON segment sensing modules 272, which, in at least some embodiments, can provide real-time information about a current state of the PON segment. This data can be crucial for understanding the existing performance metrics and environmental conditions of the example PON segment. The AI/ML model classification module 274 can be configured to utilize the input data to establish a relationships between the sensed data as feature data and predefined fiber classes, as labeled data, thereby enabling a precise classification based on the current and predicted performance.

The PON segment evaluation, classification and/or qualification module 276 can be configured to use the mapped data to evaluate the a suitability of the PON segment for future applications, determining whether a performance of the PON segment meets the necessary criteria for an advanced PON requirement, such as a high-speed optical transmission requirement. The example evaluation process can consider various factors, such as an ability of the PON segment to support advanced modulation techniques and/or resilience to other conditions, such as environmental and mechanical stresses.

In operation, the example optical fiber evaluation system 270 begins with the collection of fiber sensing data, which serves as the foundation for the classification process. The system 270 may employ one or more sophisticated algorithms to map the input data to specific fiber classes, providing a detailed analysis of a current condition and future potential of a PON segment. The PON segment evaluation, classification and/or qualification module 276 may then assesses a readiness of the PON segment for future high-speed optical networks, e.g., offering insights into necessary maintenance, upgrades, or replacements. Overall, the example optical fiber evaluation system 270 depicts a streamlined AI module that facilitates the accurate prediction and classification of optical fibers, ensuring optimal performance and reliability in evolving network environments.

FIG. 2G depicts an illustrative embodiment of an optical fiber evaluation process 270 in accordance with various aspects described herein. The optical fiber evaluation process 270 can be configured to assess and predict the performance of optical fibers for future high-speed transmission capabilities. The process 270 begins with generating labeled training data based on historical performance data and/or based on one or more high-speed PON simulation(s) at 271, where historical data can be collected and labeled to serve as a foundation for model training. The process 270 continues by training an AI model adapted to perform predictive qualification of an optical fiber at 272, where the AI model can be trained using the labeled data to develop predictive capabilities. The process 270 continues by measuring current performance of the optical fiber at 273, where real-time data is collected to assess the current state of the fiber. Finally, the process 270 concludes with applying current performance data to the trained model to obtain estimated performance of optical fiber at 274, where the trained model uses the current data to generate predictions about the fiber's future performance and suitability for high-speed transmission. This flowchart provides a structured approach to evaluating optical fibers, integrating historical data, AI model training, and real-time performance assessment to ensure network readiness for future demands.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

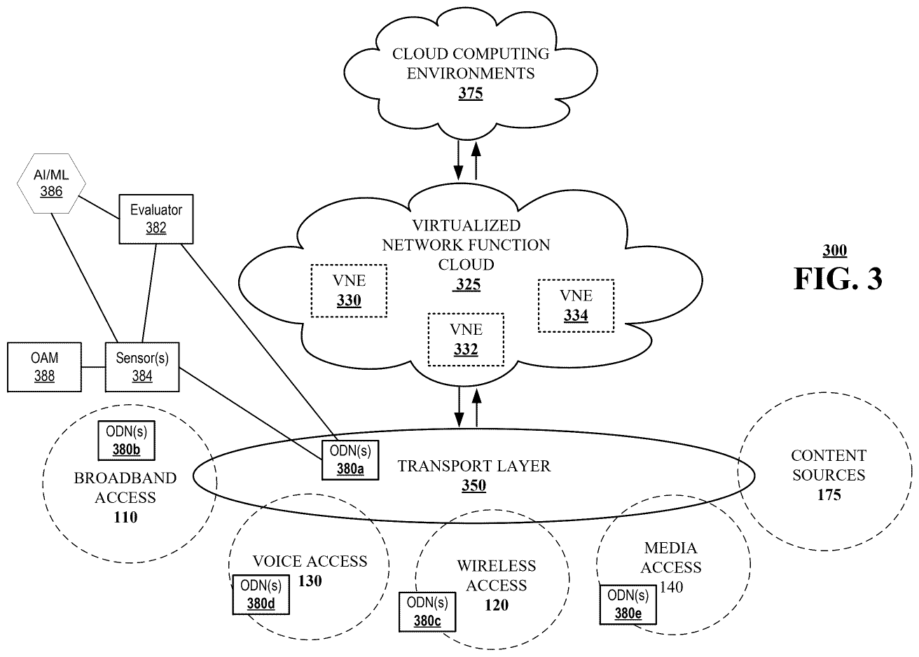

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of the communication system 100, the subsystems and functions of the other systems 200, 220, 230, 250, 260, 270 and process 280 presented in FIGS. 1, 2A, 2B, 2C, 2D, 2E, 2F, 2G and 3. For example, virtualized communication network 300 can facilitate in whole or in part generation of labeled training data based on historical optical fiber performance data and indicative of optical fiber aging and performance degradation and training of an AI processing module according to the labeled training data to obtain a trained predictive model adapted to perform qualification of an optical fiber according to aging and performance degradation. Current fiber performance data of a deployed optical fiber under evaluation can be collected and applied to the trained predictive model to obtain an estimated performance of the optical fiber under evaluation based on the current fiber performance data and execute pattern recognition to correlate environmental and mechanical factors with performance deterioration.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

In at least some embodiments, the virtualized communication network 300 includes one or more optical distribution networks (ODN). For example, the communications network transport layer 350 may include one or more ODNs 380a. Alternatively, or in addition, one or more of the broadband access network 110 may include one or more ODNs 380b, the wireless access network 120 may include one or more ODNs 380c, the voice access network 130 may include one or more ODNs 380d and/or the media access network 140 may include one or more ODNs 380e. The ODNs 380a through 380e, generally 380, may include one or more passive optical networks (PONs) that may include one or more optical fiber segments, optical fiber splitters and/or opto-electric devices, such as fiberoptic transmitters, receivers and/or transceivers, generally referred to herein as small formfactor pluggable (SFP) devices.

In at least some embodiments, the virtualized communication network 300 includes one or more sensors 382 configured to measure, monitor, detect and/or otherwise sense parameters related to the physical state, environment, electrical, optical and/or network operability of the example ODNs 380, any PONs contained therein, and devices contained therein and/or any fiber segments contained therein, all referred to generally herein as PON segments. In at least some embodiments, the virtualized communication network 300 further includes a PON segment evaluator 384 configured to evaluate one or more PON segments of the ODNs 380 base at least in part on data obtained by the one or more sensors 382. In at least some embodiments, the virtualized communication network 300 further includes an artificial intelligence and/or machine learning (AI/ML) module 386 configured to determine a quality, a characteristic, and/or an operational performance capability as may relate to a classification and/or a rating value of a PON segment. In at least some embodiments, the AI/ML module 386 trains an AI/ML model to provide a label, e.g., a quality, a characteristic, and/or an operational performance capability as may relate to a classification and/or a rating of one or more PON segments based on a set of features corresponding at least in part to measured parameters obtained via the sensors 382.

In at least some embodiments, the virtualized communication network 300 includes an operation, administration and/or maintenance (OAM) system 388. It is envisioned that the OAM system 388 may be configured to receive a label, e.g., a quality, a characteristic, and/or an operational performance capability as may relate to a classification and/or a rating of one or more PON segments. In some embodiments, the label may indicate detection of an anomaly associated with an identifiable PON segment. Alternatively, or in addition, the label may indicate that a PON segment is suitable to accommodate one or more new and/or otherwise advanced PON functions, such as advanced modulations and/or greater data rates, bandwidths, and so on.

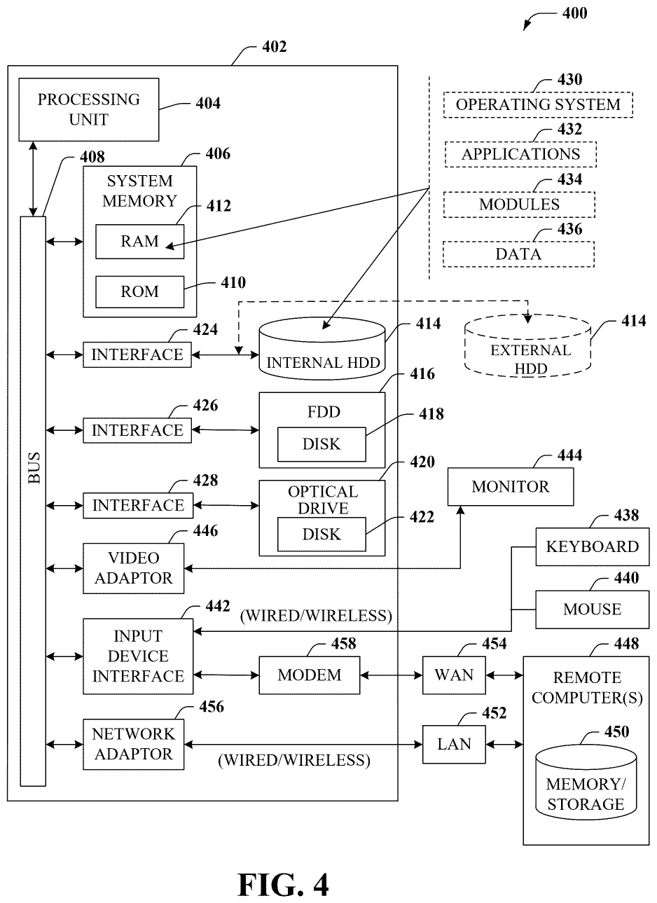

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part generation of labeled training data based on historical optical fiber performance data and indicative of optical fiber aging and performance degradation and training of an AI processing module according to the labeled training data to obtain a trained predictive model adapted to perform qualification of an optical fiber according to aging and performance degradation. Current fiber performance data of a deployed optical fiber under evaluation can be collected and applied to the trained predictive model to obtain an estimated performance of the optical fiber under evaluation based on the current fiber performance data and execute pattern recognition to correlate environmental and mechanical factors with performance deterioration.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

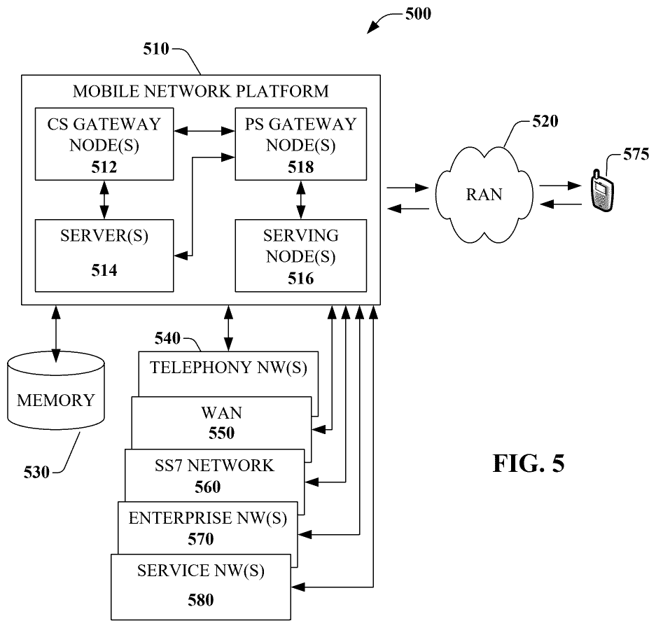

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part generation of labeled training data based on historical optical fiber performance data and indicative of optical fiber aging and performance degradation and training of an AI processing module according to the labeled training data to obtain a trained predictive model adapted to perform qualification of an optical fiber according to aging and performance degradation. Current fiber performance data of a deployed optical fiber under evaluation can be collected and applied to the trained predictive model to obtain an estimated performance of the optical fiber under evaluation based on the current fiber performance data and execute pattern recognition to correlate environmental and mechanical factors with performance deterioration. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

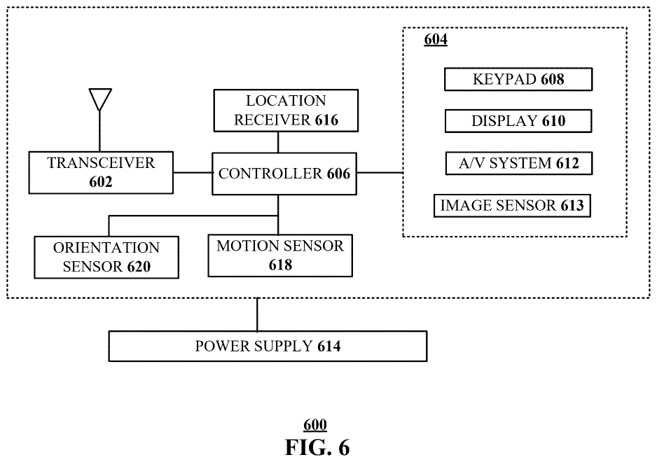

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part generation of labeled training data based on historical optical fiber performance data and indicative of optical fiber aging and performance degradation and training of an AI processing module according to the labeled training data to obtain a trained predictive model adapted to perform qualification of an optical fiber according to aging and performance degradation. Current fiber performance data of a deployed optical fiber under evaluation can be collected and applied to the trained predictive model to obtain an estimated performance of the optical fiber under evaluation based on the current fiber performance data and execute pattern recognition to correlate environmental and mechanical factors with performance deterioration.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
generating labeled training data based on optical fiber performance data, wherein the labeled training data are indicative of optical fiber aging and performance degradation;
training an artificial intelligence (AI) processing module according to the labeled training data to obtain a trained predictive model adapted to perform qualification of an optical fiber according to aging and performance degradation;
collecting current fiber performance data of a deployed optical fiber under evaluation; and
applying the current fiber performance data to the trained predictive model to obtain an estimated performance of the optical fiber under evaluation based on the current fiber performance data and execute pattern recognition to correlate environmental and mechanical factors with performance deterioration.

2. The device of claim 1, wherein the operations further comprise:
processing the current fiber performance data according to any combination of aggregating, normalizing, or storing the current fiber performance data to obtain processed fiber performance data.

3. The device of claim 1, wherein the collecting the current fiber performance data further comprises collecting the current fiber performance data from a plurality of heterogeneous sources.

4. The device of claim 3, wherein the plurality of heterogeneous sources comprises any combination of one or more of an environmental sensor, a network performance monitor, or installation data.

5. The device of claim 1, wherein the operations further comprise:
performing pattern recognition to correlate environmental and mechanical factors with performance deterioration.

6. The device of claim 1, wherein the operations further comprise:
generating recommendations for fiber segments based on the trained predictive model, wherein the recommendations are based on suitability of the fiber segments for supporting future high-speed passive optical network access transmission.

7. The device of claim 6, wherein the recommendations further comprise maintenance, replacement, or upgrade of the fiber segments.

8. The device of claim 1, wherein the optical fiber performance data comprises any combination of optical time domain reflectometry data, spectral attenuation data, polarization mode dispersion data, and chromatic dispersion data.

9. The device of claim 1, wherein the current fiber performance data comprises any combination of optical time domain reflectometry measurement data, spectral attenuation test result data, polarization mode dispersion measurement data, or chromatic dispersion measurement data.

10. The device of claim 1, wherein the trained predictive model is adapted to perform anomaly detection.

11. The device of claim 1, wherein the performance degradation is attributable to environmental factors and mechanical factors.

12. The device of claim 1, wherein the optical fiber performance data is based historical optical fiber performance, high-speed PON simulation data or a combination thereof.

13. A method, comprising:
generating, by a processing system including a processor, labeled training data based on performance data of an optical channel, wherein the labeled training data are indicative of performance of an optical channel according to at least one physical property of the optical channel subject to performance degradation during deployment;
training, by the processing system, an artificial intelligence (AI) processing module according to the labeled training data to obtain a trained predictive model adapted to perform qualification of the optical channel according to the performance degradation;
measuring, by the processing system, current performance of the optical channel to obtain current channel performance data; and
applying, by the processing system, the current channel performance data to the trained predictive model to obtain an estimated performance of the optical channel under evaluation based on the current channel performance data.

14. The method of claim 13, wherein the applying the current channel performance data to the trained predictive model further comprises:
execute, by the processing system, pattern recognition to correlate environmental and mechanical factors with performance degradation.

15. The method of claim 13, wherein the performance data comprises any combination of optical time domain reflectometry data, spectral attenuation data, polarization mode dispersion measurement, and chromatic dispersion data, as may be obtained by measurement, simulation or a combination thereof.

16. The method of claim 13, further comprising:
generating, by the processing system, recommendations for optical channel segments based on the trained predictive model, wherein the recommendations are based on suitability of the optical channel segments for supporting future high-speed passive optical network access transmission.

17. The method of claim 16, wherein the recommendations further comprise maintenance, replacement, or upgrade of the optical channel segments.

18. A non-transitory, machine-readable medium, comprising executable instructions that, when executed by a processing system including a processor, facilitate performance of operations, the operations comprising:
generating labeled training data based on performance data of an optical waveguide, wherein the labeled training data are indicative of performance of the optical waveguide according to at least one physical property of the optical waveguide subject to performance degradation during deployment;
training an artificial intelligence (AI) processing module according to the labeled training data to obtain a trained predictive model adapted to perform qualification of the optical waveguide according to the performance degradation;
measuring current performance of the optical waveguide under evaluation to obtain current performance data; and
applying the current performance data to the trained predictive model to obtain an estimated performance of the optical waveguide under evaluation based on the current performance data.

19. The non-transitory, machine-readable medium of claim 18, wherein the operations further comprise:
generating recommendations for waveguide segments based on the trained predictive model, wherein the recommendations are based on suitability of the waveguide segments for supporting future high-speed passive optical network access transmission.

20. The non-transitory, machine-readable medium of claim 19, wherein the recommendations further comprise maintenance, replacement, or upgrade of the waveguide segments.
